(19) United States
(12) Patent Application Publication
(10) Pub. No.: US 2007/0091156 A1
(43) Pub. Date: Apr. 26, 2007

(54) Inkjet ink

(76) Inventor: Christian Jackson, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/525,675

(22) Filed: Sep. 22, 2006

Related U.S. Application Data
(60) Provisional application No. 60/728,543, filed on Oct. 20, 2005.

(51) Int. Cl. C09D 11/02; G01D 11/00

(52) U.S. Cl. 347/100; 106/31.58; 106/31.43; 106/31.49; 106/31.36

(57) ABSTRACT

The present invention pertains to an aqueous inkjet ink comprising a particular vehicle which provides good print reliability and excellent decap performance (or latency) with dye colorants.

### CROSS-REFERENCE TO RELATED APPLICATION

This application claims priority under 35 U.S.C. §119 from U.S. Provisional Application Ser. No. 60/728,543, filed Oct. 20, 2005.

### BACKGROUND OF THE INVENTION

The present invention pertains to an aqueous inkjet ink comprising a particular vehicle which provides good print reliability and excellent decap performance (or latency) with dye colorants.

Inkjet printing is a non-impact printing process in which droplets of ink are deposited on a substrate, such as paper, to form the desired image. The droplets are ejected from a printhead in response to electrical signals generated by a microprocessor. Inkjet printers offer low cost, high quality printing and have become a popular alternative to other types of printers.

A good inkjet ink is characterized by a number of necessary properties, including color, jettability, decap time (latency), drying time and shelf life, among others. However, there is often a tradeoff between these properties because improving one property can result in the deterioration of another property.

Inkjet printhead technology has developed to deliver very small drop sizes. Drop volumes of 1-2 pL are currently possible, forming dots on the paper that, individually, may be substantively invisible to the human eye, but collectively capable of producing extremely high resolution images such as photographic prints with no visible graininess. In addition smaller drops allow an image to be formed with less ink volume for a given image size, and this reduces dry-time and improves printer throughput. However, in order to obtain highly colored and chromatic images with less ink, more colorant must be incorporated into the ink.

High colorant concentrations can lead to problems with print reliability and latency (the amount of time a printhead can be left uncapped and idle and still fire a drop properly) as the ink dries in the nozzle and the dye molecules aggregate blocking the nozzle or causing misdirected drops. This problem is further exacerbated by the small diameter of the nozzles designed to deliver small volume drops. The smaller nozzles can clog more easily and, in addition, require a greater force to clear any high viscosity blockage.

An additional problem with higher dye concentration inks is that the dye is more likely to aggregate as it dries on the media, such as glossy photographic paper, causing a phenomenon of “bronzing” whereby specular reflected light appears colored. This is most common in cyan dyes where a reddish bronzing is seen, but can occur with other dyes. Bronzing also increases the glossiness of an the image relative to the substrate causing gloss non-uniformity between different colored areas and the white background. US2004/0003755 (the disclosure of which is incorporated by reference herein for all purposes as if fully set forth) discloses inks with antibronzing properties, in particular inks comprising cyan dye.

One way to improve decap is to add large concentrations of non-volatile humectants to the ink, however this leads to unacceptable increases in ink viscosity, and to slow drying of the ink on the substrate and feathering.

Banding can also occur, which is a defect that appears as a line between subsequent passes of the printhead over the media. This is generally due to poor ink spread or coalescence.

There is thus a need for an inkjet ink formulation that provides outstanding decap performance while maintaining reliability and other important jetting characteristics. In particular, there is a need for such a formulation where the colorant is a dye present in relatively high concentration. Still further there is needed a formulation that will provide the foregoing properties with little or no banding, and with a minimal amount of bronzing to the extent possible.

### SUMMARY OF THE INVENTION

In accordance with the present invention, it was found that an aqueous inkjet ink comprising a dye colorant in combination with certain co-solvents and humectants can provide surprisingly long latency and high reliability.

Thus, in one aspect, the present invention pertains to an aqueous inkjet ink comprising a dye colorant solubilized in an aqueous vehicle, wherein the aqueous vehicle comprises water, a first co-solvent, and at least one of a first or second humectant; wherein

(i) the first co-solvent is selected from the group consisting of 1,5-pentanediol, 1,6-hexanediol and mixtures thereof;

(ii) the first humectant is selected from the group consisting of urea, 2-pyrrolidone, sulfolane, tetramethylene sulfoxide, gamma-butyrolactone, 1,3-dimethyl-2-imidazolidinone, bis-hydroxyethyl-5,5-dimethylhydantoin and mixtures thereof; and

(iii) the second humectant is a (one or more) water-soluble organic molecule having at least two hydroxyl (alcohol) groups and a carbon/oxygen ratio of two or less,

provided that, when the first co-solvent is not a mixture of 1,5-pentanediol and 1,6-hexanediol, the inkjet ink further comprises a second co-solvent selected from the group consisting of 1,2-pentanediol, 1,2-hexanediol, 1,2-heptanediol, 1,2-octanediol and mixtures thereof.

For clarification, when the first co-solvent is other than a mixture of both 1,5-pentanediol and 1,6-hexanediol, that is, only 1,5-pentanediol or only 1,6-hexanediol, the second co-solvent must be present. When the first co-solvent is both (a mixture of) 1,5-pentanediol and 1,6-hexanediol, the second co-solvent is optional.

In accordance with another aspect of the present invention, there is provided an inkjet ink set comprising at least two differently colored inks, wherein at least one of the inks is an inkjet ink as set forth above. Preferably, at least one of the inks is an inkjet ink as set forth above, wherein the dye colorant is DB199, AY23 or AR249.

In yet another aspect of the present invention, there is provided a method for inkjet printing onto a substrate, comprising the steps of:

(a) providing an inkjet printer that is responsive to digital data signals;

(b) loading the printer with a substrate to be printed;

(c) loading the printer with an ink as set forth above and described in further detail below, or an inkjet ink set as set forth above and described in further detail below; and

(d) printing onto the substrate using the ink or inkjet ink set in response to the digital data signals.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### DETAILED DESCRIPTION OF THE PREFERRED EMBODIMENTS

Vehicle

The ink vehicle is the liquid carrier (or medium) for the colorant(s). An “aqueous vehicle” in the context of the present invention is a mixture of water and organic water-soluble vehicle components typically referred to as co-solvents or humectants. Sometimes in the art, when a co-solvent can assist in the penetration and drying of an ink on a printed substrate, it is also referred to as a penetrant.

The instant invention employs a specific combination of organic water-soluble vehicle components. In various embodiments there is prescribed a first co-solvent, an optional second co-solvent, and one or both of a first humectant and a second humectant.

The first co-solvent is one or a combination of 1,5-pentanediol and 1,6-hexanediol. Generally, the ink will comprise at least about 1 wt %, and no more than about 20 wt %, of the first co-solvent (total), based on the total weight of the ink. More typically, the ink will comprise from about 1 wt % to about 10 wt % of the first co-solvent. In one preferred embodiment, the ink comprises greater than about 3 wt % of the first co-solvent, and preferably from about 4 wt % to about 10 wt % of the first co-solvent. In another embodiment, when only the first co-solvent is used, it is preferably present in an amount of at least about 4 wt % and, when the first co-solvent is utilized in amounts less than about 4 wt %, it is preferred that the second co-solvent is also utilized.

The second co-solvent is one or combination of 1,2-pentanediol, 1,2-hexanediol, 1,2-heptanediol and 1,2-octanediol. When the second co-solvent is present, the ink will generally comprise at least about 0.1 wt %, and no more than about 20 wt %, of the second co-solvent (total), based on the total weight of the ink. More typically, the ink will comprise from about 0.5 wt % to about 10 wt % of the second co-solvent.

When both the first and second co-solvents are present, the total amount of the two should not exceed about 20 wt % based on the total weight of the ink. Preferably, the combined amount of first and second co-solvents is between about 3.5 wt % up to about 20 wt %.

The first humectant is any one or combination of urea, 2-pyrrolidone, sulfolane (also known as tetramethylene sulfone and tetrahydrothiophene-1,1-dioxide), tetramethylene sulfoxide (also known as tetrahydrothiophene oxide), gamma-butyrolactone, bis-hydroxyethyl-5,5-dimethylhydantoin (also known as di-(2-hydroxyethyl)-5,5-dimethylhydantoin), and 1,3-dimethyl-2-imidazolidinone. Preferred first humectants are urea and 2-pyrrolidone (and mixtures thereof).

The second humectant is any one or combination of water-soluble organic molecules having at least two hydroxyl (alcohol) groups and a carbon/oxygen ratio of two or less. Preferably the second humectant has a carbon/oxygen ratio of less than two, even more preferably less than 1.5. Also, the molecular weight is preferably less than 600 Daultons, more preferably less than 350 Daultons.

Preferably, the second humectant is substantially neutral (neither acidic nor basic, nor salt thereof) and, therefore, does not contain, for example, carboxylic acid groups.

In a preferred embodiment, the second humectant is comprised of only carbon, hydrogen and oxygen. Specific preferred second humectants include glycerol, ethylene glycol, diethylene glycol, triethylene glycol, tetraethylene glycol, saccharides and saccharide derivatives, propylene glycol, and any combination thereof.

Saccharides are, for example, monosaccharides and disaccharides, including glucose, mannose, fructose, ribose, xylose, arabinose, galactose, maltose, cellobiose, lactose, sucrose, trehalose and maltotriose. Saccharide derivatives such as sugar alcohols are also useful. Sugar-alcohols, represented by the general formula
HOCH₂(CHOH)ₙCH₂OH
in which n is an integer of 2 to 5, include, for example, threitol, erythritol, arabitol, ribitol, xylitol, lyxitol, sorbitol, mannitol, iditol, gulcitol, talitol, galactitol, allitol, altritol, maltitol, isomaltitol, lactitol, and turanitol.

A summary of hydroxyl (alcohol) groups, a carbon/oxygen ratio content of various second humectants is given in the following table.

| Second | Number of | Number of | Number of | C/O | Molecular |
|---|---|---|---|---|---|
| Humectant | hydroxyls | carbons | oxygens | ratio | weight |
| Ethylene glycol | 2 | 2 | 2 | 1 | 62 |
| Propylene glycol | 2 | 3 | 2 | 1.5 | 76 |
| Diethylene glycol | 2 | 4 | 3 | 1.33 | 106 |
| Triethylene glycol | 2 | 6 | 4 | 1.5 | 150 |
| Glycerol | 3 | 3 | 3 | 1 | 92 |
| 1,2,6-hexanetriol | 3 | 6 | 3 | 2 | 134 |
| Trimethylol- | 3 | 6 | 3 | 2 | 134 |
| propane | | | | | |
| Xylose | 4 | 5 | 5 | 1 | 150 |
| Fructose | 5 | 6 | 6 | 1 | 180 |

The total amount of first humectant, when present in the final ink (cumulative), is generally between about 1 wt % and about 20 wt %, more typically between about 2 wt % and about 15 wt %, based on the total weight of the ink. The first humectant is preferably present in an amount greater than about 2 wt %, and more preferably at least about 3 wt %, and can advantageously be present in amounts of about 10 wt % or more.

The total amount of second humectant, when present in the final ink, is generally between about 1 wt % and about 25 wt %, and more typically between about 2 wt % and about 20 wt %, based on the total weight of the ink.

The total humectant content, when one or both of the first and second humectants are present, is generally greater than about 6 wt %, preferably at least about 8 wt %, and more preferably at least about 15 wt %, and generally less than about 29 wt % and preferably less than about 25 wt %, based on the total weight of the ink.

The most preferred levels of ingredients will be composition and end-use specific and for example, may be related to dye and dye content, as well as desired ink properties. The preferred levels can be generally determined by routine experimentation based on these parameters.

The aqueous vehicle may optionally comprise other organic, water-soluble vehicle components. For example, a vehicle may comprise one or more penetrants such as a glycol ether. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether.

The aqueous vehicle typically will contain from about 65 wt % to about 94 wt % water with the balance (i.e., from about 35 wt % to about 6 wt %) being organic water-soluble vehicle components such as the humectants. Preferred compositions contain from about 70 wt % to about 90 wt % water, based on the total weight of the aqueous vehicle.

The amount of aqueous vehicle in the ink is typically in the range of from about 70 wt % to about 99.8 wt %, and preferably about 80 wt % to about 99.8 wt %, based on the total ink weight.

Colorant

The colorant prescribed by the present invention is a dye. By definition, a dye is substantially soluble in the ink vehicle. Useful dyes include conventional dyes, such as anionic, cationic, amphoteric and non-ionic dyes. Such dyes are in general well known to those of ordinary skill in the art.

Anionic dyes are those dyes that, in aqueous solution, yield colored anions. Cationic dyes are those dyes that, in aqueous solution, yield colored cations. Typically anionic dyes contain carboxylic or sulfonic acid groups as the ionic moiety. Cationic dyes usually contain quaternary nitrogen groups.

The types of anionic dyes most useful in this invention are, for example, Acid, Direct, Food, Mordant and Reactive dyes.

Preferred anionic dyes are those selected from the group consisting of nitroso compounds, nitro compounds, azo compounds, stilbene compounds, triarylmethane compounds, xanthene compounds, quinoline compounds, thiazole compounds, azine compounds, oxazine compounds, thiazine compounds, aminoketone compounds, anthraquinone compounds, indigoid compounds and phthalocyanine compounds.

Preferred cationic dyes include mainly the basic dyes and some of the mordant dyes that are designed to bind acidic sites on a substrate, such as fibers. Useful types of such dyes include the azo compounds, diphenylmethane compounds, triarylmethanes, xanthene compounds, acridine compounds, quinoline compounds, methine or polymethine compounds, thiazole compounds, indamine or indophenyl compounds, azine compounds, oxazine compounds and thiazine compounds, among others, all of which are generally well known to those skilled in the art.

Particularly preferred for this invention are anionic dyes.

Useful CMY dyes include (cyan) Acid Blue 9 and Direct Blue 199; (magenta) Acid Red 249, Acid Red 52, Reactive Red 180, Acid Red 37 and Reactive Red 23; and (yellow) Direct Yellow 86, Direct Yellow 132 and Acid Yellow 23. Preferred are DB199, AY23 and AR249.

Useful RGB dyes include (red) Reactive Orange 16, Reactive Red 123, Reactive Red 43, Reactive Orange 13, Acid Red 337 and Acid Red 415; (blue) Reactive Blue 49, Reactive Blue 19, Reactive Blue 72, Reactive Blue 21, Acid Blue 83 and Acid Blue 260; and (green) Reactive Green 12.

Inks may also be formed from a mixture of dyes, for example a red ink may be a mixture of Reactive Red 180 and Reactive Yellow 84, and a green ink may be a mixture of Reactive Blue 72 and Reactive Yellow 85.

The preceding dyes are referred to by their “C.I.” designation established by Society Dyers and Colourists, Bradford, Yorkshire, UK and published in the The Color Index, Third Edition, 1971.

The dyes are generally present in amounts up to about 15 wt %, more typically from about 0.5 wt % to about 12 wt %, and preferably from about 3 wt % to about 10 wt %. As indicated previously, suitable inks can be made with concentrations of at least about 4 wt %, and preferably from about 4 wt % to about 10 wt %. Percentages are weight percent of the total weight of ink.

The “dye content” in a given ink refers the total dye present in that ink, whether a single dye species or a combination of two or more dye species.

In one embodiment, the ink comprises at least about 3 wt % dye and, more preferably, at least about 4 wt % dye.

Other Ingredients (Additives)

Other ingredients, additives, can be formulated into the inkjet ink to the extent that such other ingredients do not interfere with the stability and jetablity of the ink, which may be readily determined by routine experimentation. Such other ingredients are in a general sense well known in the art.

Commonly, surfactants are added to the ink to adjust surface tension and wetting properties. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec), organosilicones (e.g. Silwet® series from Witco) and fluoro surfactants (e.g. Zonyl® series from DuPont). Surfactants are typically used in the amount of about 0.01 to about 5% and more typically about 0.2 to about 2%, based on the total weight of the ink. In context of the present invention, lower content of surfactant can be advantageous, that is less than about 1%, and in one embodiment, the surfactant is present in the range of about 0.01 to 0.6%.

Polymers may be added to the ink to improve durability. The polymers can be soluble in the vehicle or dispersed (e.g. “emulsion polymer” or “latex”), and can be ionic or nonionic. Useful classes of polymers include acrylics, styrene-acrylics and polyurethanes.

Biocides may be used to inhibit growth of microorganisms.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, materials construction and the shape and size of the nozzle. The inks should have excellent storage stability for long periods so as not clog to a significant extent in an ink jet apparatus. Further, the ink should not corrode parts of the inkjet printing device it comes in contact with, and it should be essentially odorless and non-toxic.

Although not restricted to any particular viscosity range or printhead, the inventive ink is particularly suited to lower viscosity applications. Thus the viscosity (at 25° C.) of the inventive inks and fixer can be less than about 7 cps, or less than about 5 cps, and even, advantageously, less than about 3.5 cps. Thermal inkjet actuators rely on instantaneous heating/bubble formation to eject ink drops and this mechanism of drop formation generally requires inks of lower viscosity. As such, the instant inks can be particularly advantages in thermal printheads.

Ink Sets

The ink sets in accordance with the present invention preferably comprise at least two differently colored inks, more preferably at three differently colored inks (such as CMY), and still more preferably at least four differently colored inks (such as CMYK), wherein at least one of the inks is an aqueous inkjet ink as described above.

The other inks of the ink set are preferably also aqueous inks, and may contain dyes, pigments or combinations thereof as the colorant. Such other inks are, in a general sense, well known to those of ordinary skill in the art. For ink sets comprising a black ink, the black colorant advantageously comprises carbon black pigment and especially a self-dispersing carbon black pigment.

In addition to the typical CMYK inks, the ink sets in accordance with the present invention may further comprise one or more “gamut-expanding” inks, including different colored inks such as an orange ink, a green ink, a red ink and/or a blue ink, and combinations of full strength and light strengths inks such as light cyan and light magenta.

Method of Printing

The inks and ink sets of the present invention can be printed with any suitable inkjet printer. The substrate can be any suitable substrate including plain paper, such as common electrophotographic copier paper; treated paper, such as photo-quality inkjet paper; textile; and non-porous substrates including polymeric films such as polyvinyl chloride and polyester.

### EXAMPLES

Ink Preparation

Inks were prepared according to the formulations noted in each example. Ingredients, given as weight percent of the total weight of ink, were mixed together and filtered. Water was deionized. Surfynol® 465 is a surfactant from Air Products Corp (Allentown, Pa., USA). Proxel® GXL is a Biocide from Avecia (Wilmington, Del., USA).

Gloss, Chroma and Optical Density Measurements

Inks were printed on Epson Premium Glossy Photo Paper from the appropriate color printhead in a Canon i960 printer using “High Quality” print mode. Gloss was measured using a Byk Gardner Micro-Tri-Glossmeter. Optical Density (OD) and chroma were measured using a Greytag-Macbeth Spectrolino spectrometer.

Bronzing Evaluation

Prints on Epson Premium Glossy Photo Paper were evaluated visually and given the following ratings.
A A=no bronzing (most desirable); gloss<45
A=just discernable bronzing; gloss<50
B=slight bronzing; gloss<60
C=severe bronzing (least desirable) gloss>60

The bronzing values generally correlate with an increased gloss (relative to the unprinted media) so that the more severe the bronzing, the higher the gloss and the greater the undesirable gloss non-uniformity with the medium. The level of bronzing can vary sometimes depending on the particular batch of dye (perhaps related to impurity profile). For comparison of bronzing, batch integrity of dye (especially DB199) was maintained.

Banding Evaluation

Banding is a defect that appears as a line between subsequent passes of the printhead over the media. This generally occurs due to poor ink spread or coalescence.

The prints on Epson Premium Glossy photo paper were judged visually for banding and rated “yes” (banding evident) or “no” (no banding evident).

Latency Test

Latency (decap time) was determined according to the following procedure using a Hewlett Packard 850 printer that was altered so that the ink cartridge would not be serviced during the test. Just prior to the beginning of the test, the nozzles were primed and a nozzle check pattern was performed to ensure all nozzles were firing acceptably. No further servicing was then conducted

During each scan across the page, the pen printed a pattern of 149 vertical lines spaced about 1/16 inch apart. Each vertical line was formed by all nozzles firing one drop; therefore, the line was one drop wide and about ½ inch high corresponding to the length of the nozzle array on the printhead. The first vertical line in each scan was the first drop fired from each nozzle after the prescribed latency period, the fifth line was the fifth drop from each nozzle on that scan, and so forth for all 149 lines.

The pattern was repeated at increasingly longer time intervals (decap times) between scans. The standard time intervals between scans were 1, 2, 3, 4, 5, 6, 7, 8, 9, 10, 20, 30, 40, 50, 60, 70, 80, 90 100, 200, 300, 400, 500, 600, 700, 800, 900, and 1000 seconds. Nothing beyond 1000 seconds was attempted.

Upon completion of the test, the 1^{st}, 5^{th}, and 32^{nd} vertical lines in each scan was examined for consistency, misdirected drop deposits and clarity of the print. These lines corresponded to the 1^{st}, 5^{th} and 32^{nd} ink droplets ejected from the nozzle after a prescribed latency period. The decap time for each drop was the longest time interval where the particular vertical line could be printed without significant defects.

Preferably, the pen would fire properly on the first drop. However, when the first drop failed to eject properly, the decap time for the fifth and thirty-second drops provided some information as to the severity of the pluggage and how easily the nozzles could be recovered.

The results tables hereinafter report only the first drop decap time, and refer to the value simply as the “Decap” in units of seconds.

### Example 1

Inks were prepared according to the recipes in the following table and printed. Results show the inventive inks combine excellent decap, print quality and gloss reduction, and minimize or eliminate bronzing and banding.

| Ingredients | Ink 1a | Ink 1b | Ink 1c |
|---|---|---|---|
| DB 199 (cyan dye) | 6.0 | 6.0 | 6.0 |
| Diethylene glycol | 5.0 | 5.0 | 5.0 |
| 2-Pyrrolidinone | 3.0 | 3.0 | 3.0 |
| Urea | 7.0 | 7.0 | 7.0 |
| 1,2-Hexanediol | 1.5 | 2.0 | 3.0 |
| 1,6-Hexanediol | 1.5 | 2.0 | 3.0 |
| Surfynol ® 465 | 0.1 | 0.25 | 0.25 |
| Water | Bal. to 100 | Bal. to 100 | Bal. to 100 |
| Ink Properties | | | |
| Surface Tension (dynes/cm) | 37.45 | 32.7 | 32.0 |
| Viscosity (cps) | 1.82 | 1.97 | 2.2 |
| pH | 7.1 | 7.2 | 7.0 |
| Print Properties | | | |
| 60° gloss | 64 | 44 | 44 |
| Optical Density | 2.07 | 2.30 | 2.25 |
| Chroma | 64 | 65 | 64 |
| Bronzing | C | AA | AA |
| Banding | No | No | No |
| Decap (seconds) | 600 | >1,000 | >1,000 |

### Example 2

Inks were prepared according to the recipes in the following table and printed. Results show the inventive inks combine excellent decap, print quality and gloss reduction, and minimize or eliminate bronzing and banding.

| Ingredients | Ink 2a | Ink 2b |
|---|---|---|
| DB 199 | 6.0 | 6.0 |
| Diethylene glycol | 5.0 | 5.0 |
| 2-Pyrrolidinone | 3.0 | 3.0 |
| Urea | 7.0 | 7.0 |
| 1,2-Pentanediol | 3.0 | — |
| 1,5-Pentanediol | 3.0 | 3.0 |
| 1,2-Octanediol | — | 0.5 |
| Surfynol ® 465 | 0.25 | 0.25 |
| Water | Bal. to 100 | Bal. to 100 |
| Physical Properties | | |
| Surface Tension (dynes/cm) | 28.9 | 26.6 |
| Viscosity (cps) | 2.2 | 1.8 |
| pH | 7.2 | 7.1 |
| Print Properties | | |
| 60° gloss | 40 | 43 |
| Optical Density | 2.29 | 2.31 |
| Chroma | 66 | 65 |
| Bronzing | AA | AA |
| Banding | No | No |
| Decap (seconds) | >1,000 | >1,000 |

### Example 3

This example demonstrates a CMY dye ink set with high colorant loading. Results show the inventive inks combine excellent decap, print quality and gloss reduction, and minimize or eliminate bronzing and banding.

| Ingredients | Ink 3a | Ink 3b | Ink 3c |
|---|---|---|---|
| DB 199 (cyan dye) | 5.0 | — | — |
| AR 249 (magenta dye) | — | 5.0 | — |
| AY 23 (yellow dye) | — | — | 5.0 |
| Diethylene Glycol | 5.0 | 5.0 | 5.0 |
| Glycerol | 5.0 | 5.0 | 5.0 |
| 2-Pyrrolidinone | 3.0 | 3.0 | 3.0 |
| Urea | 6.0 | 6.0 | 6.0 |
| 1,2-Hexanediol | 3.0 | 3.0 | 3.0 |
| 1,5-Pentanediol | 3.0 | 3.0 | 3.0 |
| Surfynol ® 465 | 0.5 | 0.5 | 0.5 |
| Water | Bal. to 100 | Bal. to 100 | Bal. to 100 |
| Physical Properties | | | |
| Surface Tension (dynes/cm) | 34.5 | 34.7 | 35.5 |
| Viscosity (cps) | 3.58 | 3.77 | 2.95 |
| pH | 7.16 | 6.67 | 7.59 |
| Print Properties | | | |
| 60° gloss | 43 | 45 | 48 |
| Optical Density | 2.23 | 1.94 | 1.71 |
| Chroma | 70 | 79 | 120 |
| Bronzing | AA | A | A |
| Banding | No | No | No |
| Decap (seconds) | >1,000 | >1,000 | >1,000 |

### Example 4

This example shows the benefits of the inventive inks—excellent decap, banding and lack of bronzing—can be attained with small amounts of surfactant or without any surfactant at all. However, it appears that the presence of too much surfactant (Ink 4e) can cause the beneficial effects to be lost or reduced.

| Ink ingredients | Ink 4 | Ink 4b | Ink 4c | Ink 4d | Ink 4e |
|---|---|---|---|---|---|
| DB 199 | 6.0 | 6.0 | 6.0 | 6.0 | 6.0 |
| Diethylene Glycol | 5.0 | 5.0 | 5.0 | 5.0 | 5.0 |
| 2-Pyrrolidinone | 3.0 | 3.0 | 3.0 | 3.0 | 3.0 |
| Urea | 7.0 | 7.0 | 7.0 | 7.0 | 7.0 |
| 1,2-Pentanediol | 3.0 | 3.0 | — | — | — |
| 1,5-Pentanediol | — | — | 3.0 | 3.0 | 3.0 |
| 1,2-Hexanediol | — | — | 3.0 | 3.0 | 3.0 |
| 1,6-Hexanediol | 3.0 | 3.0 | — | — | — |
| Surfynol ® 465 | 0.25 | — | 0.25 | — | 1.0 |
| Water | Bal. to 100 | Bal. to 100 | Bal. to 100 | Bal. to 100 | Bal. to 100 |
| Print Properties | | | | | |
| 60° gloss | 40 | 41 | 41 | 41 | 48 |
| Bronzing | AA | AA | AA | AA | A |
| Banding | No | No | No | No | No |
| Decap (seconds) | >1,000 | >1,000 | 900 | >1,000 | 200 |

### Example 5 (Comparative)

These comparative inks comprise no diols, or single diols alone. Results show that none provide a combination of low gloss, high OD, no bronzing and banding and good decap performance.

| | Ink 5a | Ink 5b | Ink 5c |
|---|---|---|---|
| Ingredients | (Comp) | (Comp) | (Comp) |
| DB 199 | 6.0 | 6.0 | 6.0 |
| Diethylene Glycol | 5.0 | 5.0 | 5.0 |
| 2-Pyrrolidone | 3.0 | 3.0 | 3.0 |
| Urea | 7.0 | 7.0 | 7.0 |
| 1,2-Hexanediol | — | 3.0 | — |
| 1,6-Hexanediol | — | — | 3.0 |
| Surfynol ® 465 | 0.1 | 0.1 | 0.1 |
| Water | Bal. to 100 | Bal. to 100 | Bal. to 100 |
| Physical Properties | | | |
| Surface Tension (dynes/cm) | 40.0 | 35.5 | 39.1 |
| Viscosity (cps) | 1.69 | 1.85 | 1.79 |
| pH | 7.3 | 7.2 | 7.3 |
| Print Properties | | | |
| 60° gloss | 85 | 72 | 45 |
| Optical Density | 1.93 | 2.03 | 2.24 |
| Chroma | 63 | 64 | 65 |
| Bronzing | C | C | A |
| Banding | No | No | Yes |
| Decap (seconds) | 200 | 300 | >1,000 |

| | Ink 5d | Ink 5e | Ink 5f |
|---|---|---|---|
| Ingredients | (Comp) | (Comp) | (Comp) |
| DB 199 | 6.0 | 6.0 | 6.0 |
| Diethylene Glycol | 5.0 | 5.0 | 5.0 |
| 2-Pyrrolidone | 3.0 | 3.0 | 3.0 |
| Urea | 7.0 | 7.0 | 7.0 |
| 1,2-Pentanediol | 3.0 | — | — |
| 1,5-Pentanediol | — | 3.0 | — |
| 1,2-Octanediol | — | — | 0.5 |
| Surfynol ® 465 | 0.25 | 0.25 | 0.1 |
| Water | Bal. to 100 | Bal. to 100 | Bal. to 100 |
| Physical Properties | | | |
| Surface Tension (dynes/cm) | 31.5 | 30.2 | 30.1 |
| Viscosity (cps) | 1.8 | 1.8 | 1.66 |
| pH | 7.2 | 7.1 | 7.1 |
| Print Properties | | | |
| 60° gloss | 50 | 41 | 79 |
| Optical Density | 2.19 | 2.37 | 2.03 |
| Chroma | 64 | 66 | 65 |
| Bronzing | B | AA | C |
| Banding | No | No | No |
| Decap (seconds) | 700 | 400 | 60 |

### Example 6 (Comparative)

These examples show that inks formulated with just the two diols (and no first or second humectant) do not give adequate decap results although they do remove bronzing and banding.

| Ingredients | Ink 6a (Comp) | Ink 6b (Comp) |
|---|---|---|
| DB 199 | 6.0% | 6.0% |
| 1,2-Hexanediol | 3.0% | 3.0% |
| 1,6-Hexanediol | 15.0% | — |
| 1,5-Pentanediol | — | 15.0% |
| Surfynol ® 465 | 0.25% | 0.25% |
| Water | Bal. to 100 | Bal. to 100 |
| Print Properties | | |
| 60° gloss | 41 | 42 |
| Bronzing | AA | AA |
| Banding | No | No |
| Decap (seconds) | 100 | 200 |

### Example 7

This example shows that the preferred use of 2-pyrrolidone or/and urea as the first humectant to obtain excellent decap.

| Ingredients | Ink 7a | Ink 7b | Ink 7c | Ink 7d | Ink 7e | Ink 7f |
|---|---|---|---|---|---|---|
| DB 199 | 6.0 | 6.0 | 6.0 | 6.0 | 6.0 | 6.0 |
| Diethylene | 15.0 | 5.0 | 5.0 | — | — | — |
| Glycol | | | | | | |
| 2-Pyrrolidinone | — | 3.0 | — | 3.0 | 15.0 | — |
| Urea | — | — | 7.0 | 7.0 | — | 15.0 |
| 1,2-Hexanediol | 3.0 | 2.0 | 2.0 | 2.0 | 3.0 | 3.0 |
| 1,6-Hexanediol | 3.0 | 2.0 | 2.0 | 2.0 | 3.0 | 3.0 |
| Surfynol ® 465 | — | 0.25 | 0.25 | 0.25 | — | — |
| Water | Bal. to 100 | Bal. to 100 | Bal. to 100 | Bal. to 100 | Bal. to 100 | Bal. to 100 |
| Print Properties | | | | | | |
| 60° gloss | 62 | 91 | 76 | 68 | 43 | 51 |
| Bronzing | C | C | C | C | AA | B |
| Banding | Yes | No | No | No | No | No |
| Decap | >1,000 | 600 | >1,000 | >1,000 | >1,000 | >1,000 |
| (seconds) | | | | | | |

### Example 8

Ink 8 demonstrates that, when the first cosolvent comprises a combination of 1,6-hexanediol and 1,5-pentanediol, excellent decap and banding performance was obtained. Bronzing, however, was not controlled.

| Ink ingredients | Ink 8 |
|---|---|
| DB 199 | 6.0 |
| Diethylene Glycol | 5.0 |
| 2-Pyrrolidinone | 3.0 |
| Urea | 7.0 |
| 1,5-Pentanediol | 3.0 |
| 1,6-Hexanediol | 3.0 |
| Surfynol ® 465 | 0.25 |
| Water | Bal. to 100 |
| Print Properties | |
| 60° gloss | 75 |
| Bronzing | C |
| Banding | No |
| Decap (seconds) | >1,000 |

1. An aqueous inkjet ink comprising a dye colorant solubilized in an aqueous vehicle, wherein the aqueous vehicle comprises water, a first co-solvent, and at least one of a first or second humectant; wherein
(i) the first co-solvent is selected from the group consisting of 1,5-pentanediol, 1,6-hexanediol and mixtures thereof;
(ii) the first humectant is selected from the group consisting of urea, 2-pyrrolidone, sulfolane, tetramethylene sulfoxide, gamma-butyrolactone, 1,3-dimethyl-2-imidazolidinone, bis-hydroxyethyl-5,5-dimethylhydantoin and mixtures thereof; and
(iii) the second humectant is a water-soluble organic molecule having at least two hydroxyl (alcohol) groups and a carbon/oxygen ratio of two or less,
provided that, when the first co-solvent is not a mixture of 1,5-pentanediol and 1,6-hexanediol, the inkjet ink further comprises a second co-solvent selected from the group consisting of 1,2-pentanediol, 1,2-hexanediol, 1,2-heptanediol, 1,2-octanediol and mixtures thereof.

2. The aqueous inkjet ink of claim 1, wherein the first humectant is selected from the group consisting of urea, 2-pyrrolidone and mixtures thereof.

3. The aqueous inkjet ink of claim 1, wherein the second humectant is selected from the group consisting of glycerol, ethylene glycol, diethylene glycol, triethylene glycol, tetraethylene glycol, propylene glycol, saccharides, saccharide derivatives and mixtures thereof.

4. The aqueous inkjet ink of claim 1, wherein the ink comprises at least about 1 wt % and no more than about 20 wt % of the first co-solvent.

5. The aqueous inkjet ink of claim 4, wherein the ink comprises at least about 4 wt % of the first co-solvent.

6. The aqueous inkjet ink of claim 4, wherein the ink comprises at least about 0.1 wt % and no more than about 20 wt % of the second co-solvent, wherein the total of the first and second co-solvents does not exceed about 20 wt %, based on the total weight of the ink.

7. The aqueous inkjet ink of claim 6, wherein the combined amount of first and second co-solvents is between about 3.5 wt % up to about 20 wt %, based on the total weight of the ink.

8. The aqueous inkjet ink of any one or combination of claims 1-7, wherein the ink comprises at least about 6 wt % humectant content, based on the total weight of the ink.

9. The aqueous inkjet ink of claim 8, wherein the ink comprises at least about 2 wt % of the first humectant.

10. The aqueous inkjet ink of any one or combination of claims 1-9, comprising at least about 3 wt % dye based on the on the total weight of the ink.

11. The aqueous inkjet ink of claim 10, comprising at least about 4 wt % dye based on the on the total weight of the ink.

12. An inkjet ink set comprising at least two differently colored inks, wherein at least one of the inks is an inkjet ink as set forth in any one or combination of claims 1-11.

13. The inkjet ink set of claim 12, comprising at least three differently colored inks that, individually, are inkjet inks as set forth in any one or combination of claims 1-11.

14. A method for inkjet printing onto a substrate, comprising the steps of:
(a) providing an inkjet printer that is responsive to digital data signals;
(b) loading the printer with a substrate to be printed;
(c) loading the printer with an ink as set forth in any one or combination of claims 1-11, or an inkjet ink set as set forth in claim 12 or claim 13; and
(d) printing onto the substrate using the ink or inkjet ink set in response to the digital data signals.
